(19) United States
(12) Patent Application Publication
(10) Pub. No.: US 2025/0369386 A1
(43) Pub. Date: Dec. 4, 2025

(54) METHOD AND SYSTEM AND COMPUTER PROGRAM PRODUCT OF CONTROLLING VEHICLE FAN SPEED TO REGULATE COOLANT TEMPERATURE

(71) Applicant: Volvo Truck Corporation, Göteborg (SE)

(72) Inventors: Tiago Alexandre ROSSO, Paraná (BR); João Eduardo HOFFMANN, Paraná (BR); Max MAURO DIAS SANTOS, Paraná (BR); Henrique Teixeira AVILA, Paraná (BR)

(21) Appl. No.: 18/874,385

(22) PCT Filed: Jun. 30, 2022
(86) PCT No.: PCT/IB2022/056110

§ 371 Date: Dec. 12, 2024

(51) Int. Cl. F01P 7/04; F01P 7/02; F04D 27/00

(52) U.S. Cl. CPC F01P 7/04; F01P 7/026; F04D 27/004

(57) ABSTRACT

A method and a system and a computer program product are provided to control vehicle fan speed of a vehicle fan hardware of a vehicle to regulate coolant temperature of vehicle coolant of the vehicle. Predicted coolant temperature data and predicted thermal impact data are generated based on acquired previous coolant temperature data and acquired previous thermal impact data. A currently predicted fan speed demand is generated based on the predicted coolant temperature data. the predicted thermal impact data and previously imposed fan speed demands or an initial fan speed demand. The currently predicted fan speed demand is compared with a received real-time fan speed demand. A highest fan speed demand among the currently predicted fan speed demand and the real-time fan speed demand is determined. A control signal for controlling vehicle fan speed is generated based on the highest fan speed demand.

### TECHNICAL FIELD

The present disclosure refers to a method, a system and a computer program product of controlling vehicle fan speed of a vehicle fan hardware of a vehicle to regulate coolant temperature of vehicle coolant of the vehicle.

### BACKGROUND

As the source of power for vehicles, vehicle engines get extremely hot. Without proper protection, a vehicle engine may wear down and even melt. A significant amount of vehicle engine failures may be related in some way to vehicle engine cooling problems. To protect vehicle engines and to keep vehicle engines running at the ideal temperature, vehicle engine coolant is used. Vehicle engine coolant protects vehicle engines from overheating. When vehicle engines are running, vehicle engine coolant continuously circulates through vehicle engines. Vehicle engine coolant transfers heat so vehicle engines may stay running in optimal condition. Vehicle engine coolant is usually used in conjunction with a fan cooling system. A cooling fan is a vital part of a vehicle's cooling system. When vehicle engine coolant is too hot, a vehicle cooling fan may be switched on and activated to provide enough cooling air flow as well as increasing the amount of cooling air, thereby decreasing the temperature of vehicle engine coolant. Currently, PID (proportional-integral-derivative) controllers are widely used in vehicle fan control systems for determining fan speed to regulate the coolant temperature. However, there may be some disturbances during the PID control process of fan speed which may lead to poor regulation of the coolant temperature.

### SUMMARY

According to some embodiments of inventive concepts, a method of controlling vehicle fan speed to regulate coolant temperature is provided. The method may include performing a present fan speed demand generation iteration and performing a present fan speed demand selection and control signal generation iteration. Performing the present fan speed demand generation iteration may include acquiring previous coolant temperature data and previous thermal impact data, generating predicted coolant temperature data and predicted thermal impact data based on the previous coolant temperature data and the previous thermal impact data, and generating a currently predicted fan speed demand for a vehicle fan hardware based on the predicted coolant temperature data, the predicted thermal impact data and previously imposed fan speed demands for the vehicle fan hardware from a previous fan speed demand generation iteration or an initial fan speed demand for the vehicle fan hardware. Performing the present fan speed demand selection and control signal generation iteration may include receiving a real-time fan speed demand for the vehicle fan hardware, comparing the currently predicted fan speed demand with the real-time fan speed demand, determining a highest fan speed demand for the vehicle fan hardware among the currently predicted fan speed demand and the real-time fan speed demand, and generating a control signal for controlling vehicle fan speed of the vehicle fan hardware based on the highest fan speed demand.

According to some embodiments of inventive concepts, a system of controlling vehicle fan speed to regulate coolant temperature is provided. The system may include a processor and a sensor electrically coupled with the processor. The processor may be configured to perform operations which may include performing a present fan speed demand generation iteration and performing a present fan speed demand selection and control signal generation iteration. Performing the present fan speed demand generation iteration may include acquiring previous coolant temperature data and previous thermal impact data via the sensor, generating predicted coolant temperature data and predicted thermal impact data based on the previous coolant temperature data and the previous thermal impact data, and generating a currently predicted fan speed demand for a vehicle fan hardware based on the predicted coolant temperature data, the predicted thermal impact data and previously imposed fan speed demands for the vehicle fan hardware from a previous fan speed demand generation iteration or an initial fan speed demand for the vehicle fan hardware. Performing the present fan speed demand selection and control signal generation iteration may include receiving a real-time fan speed demand for the vehicle fan hardware, comparing the currently predicted fan speed demand with the real-time fan speed demand, determining a highest fan speed demand for the vehicle fan hardware among the currently predicted fan speed demand and the real-time fan speed demand, and generating a control signal for controlling vehicle fan speed of the vehicle fan hardware based on the highest fan speed demand.

According to some embodiments of inventive concepts, a computer program product of controlling vehicle fan speed to regulate coolant temperature is provided. The computer program product may include a non-transitory computer readable medium and a program code. The program code may be stored in the non-transitory computer readable medium that when executed by a system causes the system to perform operations which may include performing a present fan speed demand generation iteration and performing a present fan speed demand selection and control signal generation iteration. Performing the present fan speed demand generation iteration may include acquiring previous coolant temperature data and previous thermal impact data, generating predicted coolant temperature data and predicted thermal impact data based on the previous coolant temperature data and the previous thermal impact data, and generating a currently predicted fan speed demand for a vehicle fan hardware based on the predicted coolant temperature data, the predicted thermal impact data and previously imposed fan speed demands for the vehicle fan hardware from a previous fan speed demand generation iteration or an initial fan speed demand for the vehicle fan hardware. Performing the present fan speed demand selection and control signal generation iteration may include receiving a real-time fan speed demand for the vehicle fan hardware, comparing the currently predicted fan speed demand with the real-time fan speed demand, determining a highest fan speed demand for the vehicle fan hardware among the currently predicted fan speed demand and the real-time fan speed demand, and generating a control signal for controlling vehicle fan speed of the vehicle fan hardware based on the highest fan speed demand.

According to some embodiments of inventive concepts, a method of controlling vehicle fan speed to regulate coolant temperature is provided. The method, as a discrete fan speed controller, may include iteratively performing a coolant temperature and thermal impact data generation process, a fan speed demand generation process, a real-time comparative process between generated fan speed demands and requested fan speed demands and a control signal generation process. Performing an iteration of the coolant temperature and thermal impact data generation process may include acquiring previous coolant temperature data and previous thermal impact data, generating predicted coolant temperature data and predicted thermal impact data. Performing the fan speed demand generation process, as a subsequent process to the coolant temperature and thermal impact data generation process, results in the generation of predicted fan speed demands from previously predicted coolant temperature and thermal impact data, and previously imposed fan speed demands for the vehicle fan hardware. The real-time comparative process between generated fan speed demands and requested fan speed demands may be performed as an iteration subsequent to the fan speed demand generation process or parallel to the coolant temperature, thermal impact and fan speed demand data generation processes after the first iteration of each process, and it may include the reception of predicted fan speed demands in real-time and fan speed demands from real-time vehicle cooling demand requests, comparing the fan speed demand values and determining the highest fan speed demand. The control signal generation process iteration may be performed as subsequent to the real-time comparative process and generates the control signal required by the fan hardware in achieving the imposed fan speed demands.

According to some embodiments of inventive concepts, a system of controlling vehicle fan speed to regulate coolant temperature is provided. The system may include a processor and a sensor electrically coupled with the processor. The processor may be configured to perform operations which may include performing the coolant temperature and thermal impact data generation, fan speed demand generation, real-time comparison between fan speed demands and control signal generation. Performing an iteration of the coolant temperature and thermal impact data generation process may include acquiring previous coolant temperature data and previous thermal impact data, generating predicted coolant temperature data and predicted thermal impact data. Performing the fan speed demand generation process, as a subsequent process to the coolant temperature and thermal impact data generation process, results in the generation of predicted fan speed demands from previously predicted coolant temperature and thermal impact data, and previously imposed fan speed demands for the vehicle fan hardware. The real-time comparative process between generated fan speed demands and requested fan speed demands may be performed as an iteration subsequent to the fan speed demand generation process or parallel to the coolant temperature, thermal impact and fan speed demand data generation processes after the first iteration of each process, and it may include the reception of predicted fan speed demands in real-time and fan speed demands from real-time vehicle cooling demand requests, comparing the fan speed demand values and determining the highest fan speed demand. The control signal generation process iteration may be performed as subsequent to the real-time comparative process and generates the control signal required by the fan hardware in achieving the imposed fan speed demands.

According to some embodiments of inventive concepts, a computer program product of controlling vehicle fan speed to regulate coolant temperature is provided. The computer program product may include a non-transitory computer readable medium and a program code. The program code may be stored in the non-transitory computer readable medium that when executed by a system causes the system to perform operations which may include performing the coolant temperature and thermal impact data generation, fan speed demand generation, real-time comparison between fan speed demands and control signal generation. Performing an iteration of the coolant temperature and thermal impact data generation process may include acquiring previous coolant temperature data and previous thermal impact data, generating predicted coolant temperature data and predicted thermal impact data. Performing the fan speed demand generation process, as a subsequent process to the coolant temperature and thermal impact data generation process, results in the generation of predicted fan speed demands from previously predicted coolant temperature and thermal impact data, and previously imposed fan speed demands for the vehicle fan hardware. The real-time comparative process between generated fan speed demands and requested fan speed demands may be performed as an iteration subsequent to the fan speed demand generation process or parallel to the coolant temperature, thermal impact and fan speed demand data generation processes after the first iteration of each process, and it may include the reception of predicted fan speed demands in real-time and fan speed demands from real-time vehicle cooling demand requests, comparing the fan speed demand values and determining the highest fan speed demand. The control signal generation process iteration may be performed as subsequent to the real-time comparative process and generates the control signal required by the fan hardware in achieving the imposed fan speed demands.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a flowchart diagram illustrating operations of a method of controlling vehicle fan speed to regulate coolant temperature according to some embodiments of inventive concepts;

FIG. 2 is a flowchart diagram illustrating operations of a method of controlling vehicle fan speed to regulate coolant temperature according to some embodiments of inventive concepts;

FIG. 3 is a flowchart diagram illustrating operations of a method of controlling vehicle fan speed to regulate coolant temperature according to some embodiments of inventive concepts;

FIG. 4 is a flowchart diagram illustrating operations of a method of controlling vehicle fan speed to regulate coolant temperature according to some embodiments of inventive concepts;

FIG. 5 is a flowchart diagram illustrating operations of a method of controlling vehicle fan speed to regulate coolant temperature according to some embodiments of inventive concepts;

FIG. 6 is a flowchart diagram illustrating operations of a method of controlling vehicle fan speed to regulate coolant temperature according to some embodiments of inventive concepts;

FIG. 7 is a flowchart diagram illustrating operations of a method of controlling vehicle fan speed to regulate coolant temperature according to some embodiments of inventive concepts;

FIG. 8 is a flowchart diagram illustrating operations of a method of controlling vehicle fan speed to regulate coolant temperature according to some embodiments of inventive concepts;

FIG. 9 is a flowchart diagram illustrating operations of a method of controlling vehicle fan speed to regulate coolant temperature according to some embodiments of inventive concepts;

FIG. 10 is a schematic diagram illustrating a reinforcement learning labeling method for the machine learning training of controlling vehicle fan speed to regulate coolant temperature according to some embodiments of inventive concepts;

FIG. 11 is a flowchart diagram illustrating operations of a method of controlling vehicle fan speed to regulate coolant temperature according to some embodiments of inventive concepts;

FIG. 12 is a flowchart diagram illustrating operations of a method of controlling vehicle fan speed to regulate coolant temperature according to some embodiments of inventive concepts;

FIG. 13 is a schematic diagram illustrating sequential and temporal information of a method of controlling vehicle fan speed to regulate coolant temperature according to some embodiments of inventive concepts;

FIG. 14 is a schematic diagram illustrating sequential and temporal information of a method of controlling vehicle fan speed to regulate coolant temperature according to some embodiments of inventive concepts;

FIG. 15 is a flowchart diagram illustrating operations of a method of controlling vehicle fan speed to regulate coolant temperature according to some embodiments of inventive concepts;

FIG. 16 is a schematic diagram illustrating sequential and temporal information of a method of controlling vehicle fan speed to regulate coolant temperature according to some embodiments of inventive concepts;

FIG. 17 is a schematic diagram illustrating components of a system of controlling vehicle fan speed to regulate coolant temperature according to some embodiments of inventive concepts; and

FIG. 18 is a schematic diagram illustrating a computer program product of controlling vehicle fan speed to regulate coolant temperature according to some embodiments of inventive concepts.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

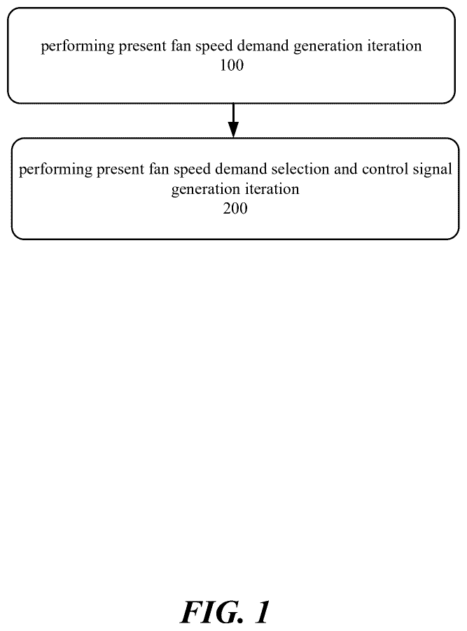

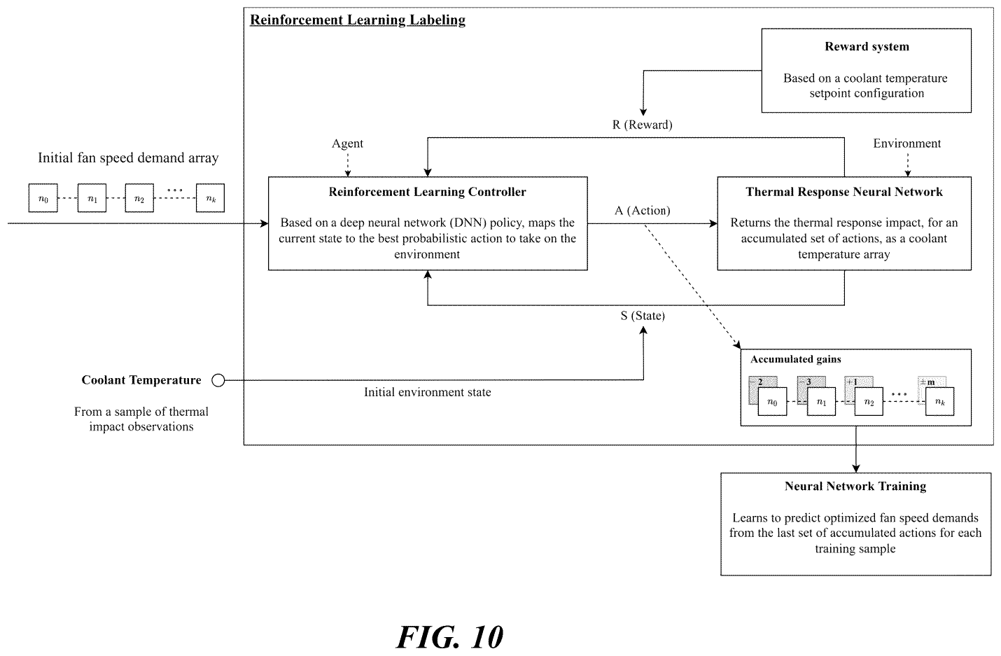

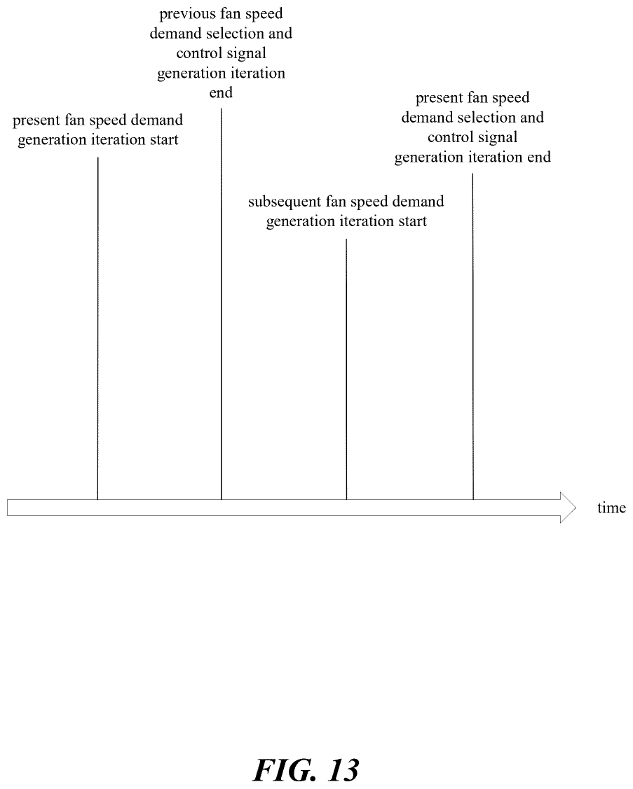

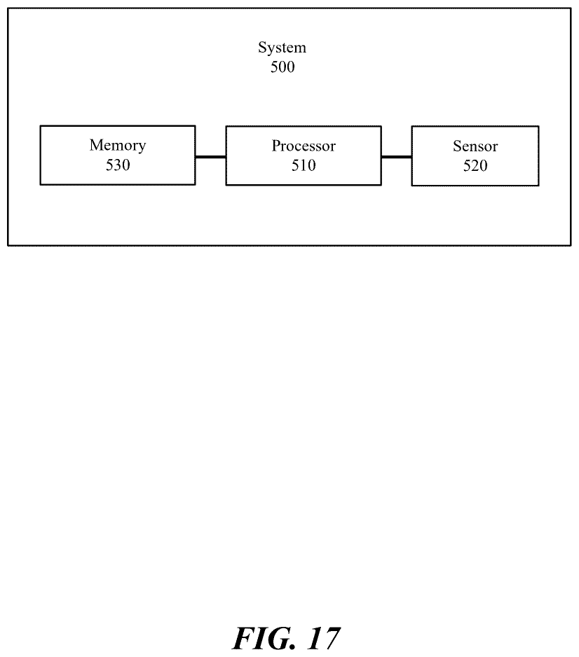

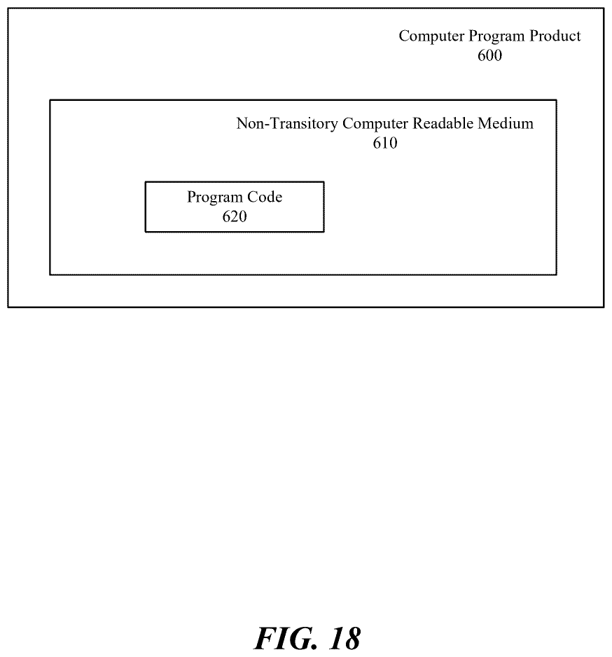

FIGS. 1-9, 11-12 and 15 are flowchart diagrams illustrating operations of a method of controlling vehicle fan speed to regulate coolant temperature according to some embodiments of inventive concepts. FIG. 10 is a schematic diagram illustrating a reinforcement learning labeling method of generating optimized fan speed demands for a coolant temperature setpoint configuration. The generated fan speed demand labels may be used to train a machine learning model for the generation of fan speed demands in regulating the coolant temperature according to some embodiments of inventive concepts. FIGS. 13-14 and 16 are schematic diagrams illustrating sequential and temporal information of a method of controlling vehicle fan speed to regulate coolant temperature according to some embodiments of inventive concepts. FIG. 17 is a schematic diagram illustrating components of a system of controlling vehicle fan speed to regulate coolant temperature according to some embodiments of inventive concepts. FIG. 18 is a schematic diagram illustrating components of a computer program product of controlling vehicle fan speed to regulate coolant temperature according to some embodiments of inventive concepts. Like numbers in the figures refer to like operations and like components.

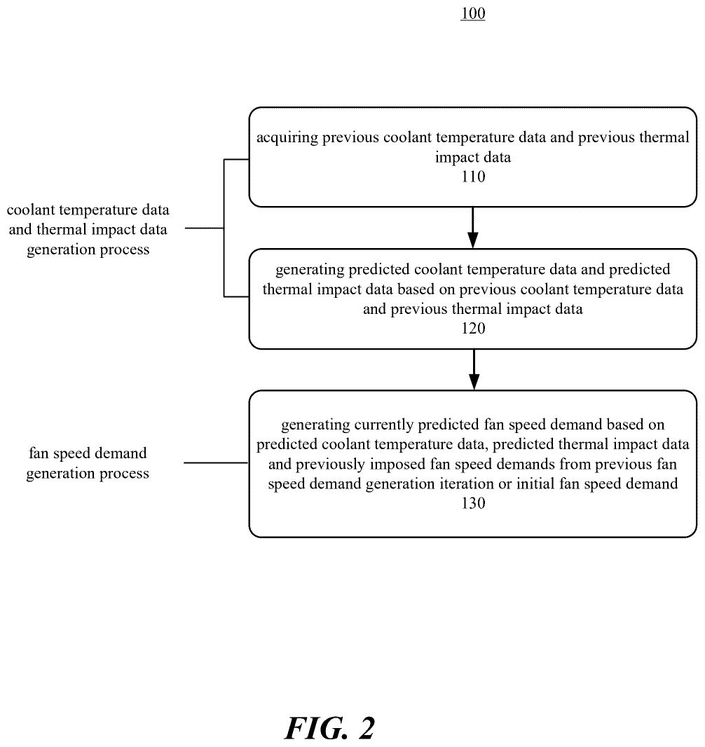

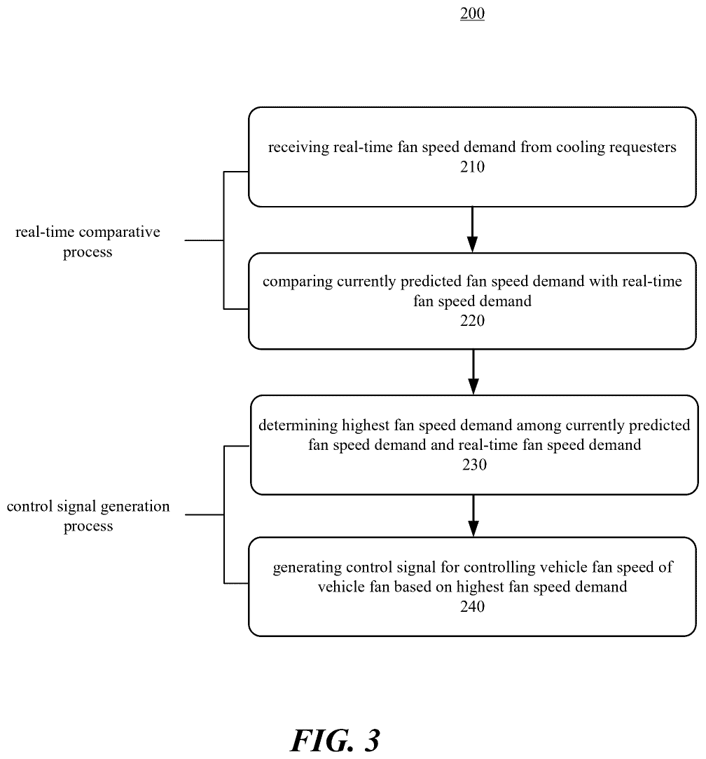

Referring now to FIG. 1, a method of controlling vehicle fan speed of a vehicle fan hardware of a vehicle to regulate coolant temperature of vehicle coolant of the vehicle is provided. In the method, a present fan speed demand selection and control signal generation iteration may be performed (block 200), as shown in FIG. 3, in response to that a present fan speed demand generation iteration may be performed (block 100), as shown in FIG. 2. The method may improve the vehicle's performance, fuel efficiency and emissions.

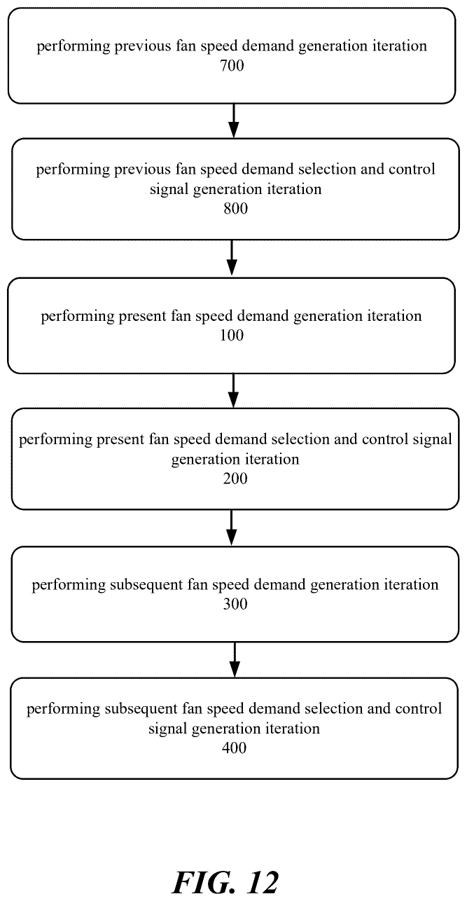

According to some embodiments, reference now is made to FIG. 2. During the present fan speed demand generation iteration, previous coolant temperature data and previous thermal impact data which may be associated with the previous coolant temperature data may be acquired (block 110). Then, during the present fan speed demand generation iteration, predicted coolant temperature data and predicted thermal impact data may be generated based on the previous coolant temperature data and the previous thermal impact data (block 120); the predicted thermal impact data may be associated with the predicted coolant temperature data. This may be referred as a coolant temperature data and thermal impact data generation process. During the present fan speed demand generation iteration, thereafter, a currently predicted fan speed demand for a vehicle fan hardware may be generated based on the predicted coolant temperature data, the predicted thermal impact data and previously imposed fan speed demands for the vehicle fan hardware from a previous fan speed demand generation iteration (block 700, as shown in FIG. 12) (for instance, a plurality of closest fan speed demands, so that there may be an accuracy improvement in predicting values, and additionally it may support a machine learning model's knowledge of possible limitations for a defined discrete sampling time) or an initial fan speed demand for the vehicle fan hardware (block 130). This may simply be referred as a fan speed demand generation process.

As can be seen in FIG. 3, according to some embodiments, during the present fan speed demand selection and control signal generation iteration, a real-time fan speed demand for the vehicle fan hardware may be received (block 210), for instance, from cooling requesters; therefore, the currently predicted fan speed demand may be compared with the real-time fan speed demand (block 220). This may be referred as a real-time comparative process. Next, during the present fan speed demand selection and control signal generation iteration, a highest fan speed demand for the vehicle fan hardware among the currently predicted fan speed demand and the real-time fan speed demand may be determined (block 230), such that the optimized fan speed demand may be generated; thus, a control signal for controlling vehicle fan speed of the vehicle fan hardware may be generated based on the highest fan speed demand (block 240), such that the coolant temperature of the vehicle coolant of the vehicle may be regulated to be maintained in a range of configurable temperature set points, and the cooling performance of the vehicle may accordingly be optimized. This may be referred as a control signal generation process.

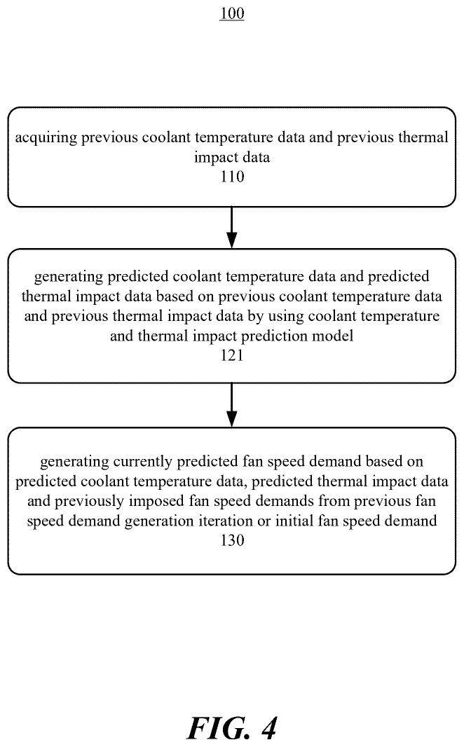

According to some embodiments, as can be seen in FIG. 4, during the present fan speed demand selection and control signal generation iteration, the predicted coolant temperature data and the predicted thermal impact data may be generated based on the previous coolant temperature data and the previous thermal impact data by using a coolant temperature and thermal impact prediction model (block 121).

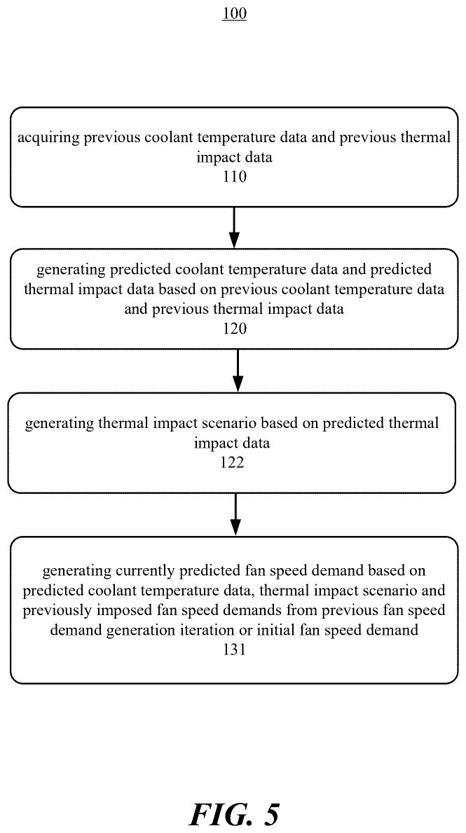

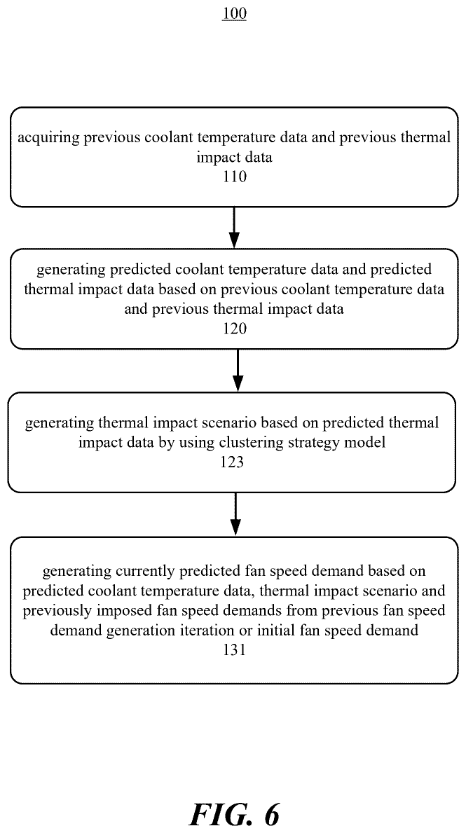

According to some embodiments, as can be seen in FIG. 5, during the present fan speed demand generation iteration, after the predicted coolant temperature data and the predicted thermal impact data may be generated (block 120), a thermal impact scenario, as selected and/or extracted features that improve the capture of relevant patterns by subsequential thermal impact receiver models while preserving the temporal aspect of the original variables, may be generated based on the predicted thermal impact data (block 122); the currently predicted fan speed demand may therefore be generated based on the predicted coolant temperature data, the thermal impact scenario and the previously imposed fan speed demands or the initial fan speed demand (block 131), defined according to the vehicle dynamics and fan speed states before the first control iteration; furthermore, according to some embodiments, as can be seen in FIG. 6, the thermal impact scenario may be generated based on the predicted thermal impact data by using a clustering strategy model (block 123).

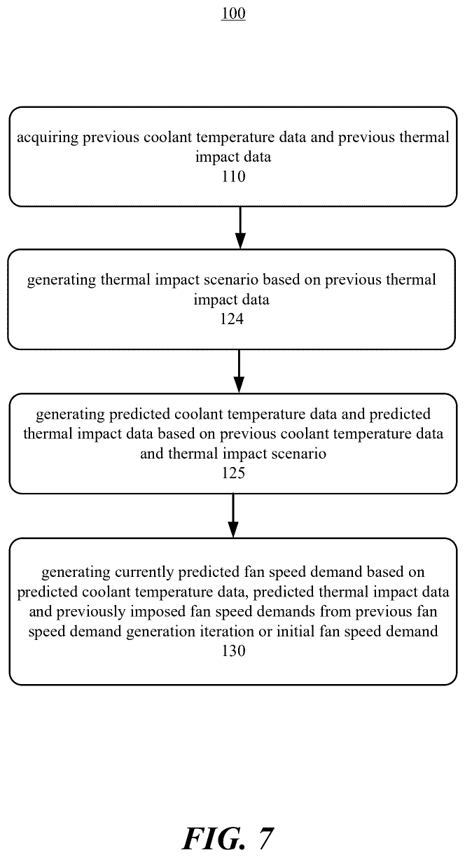

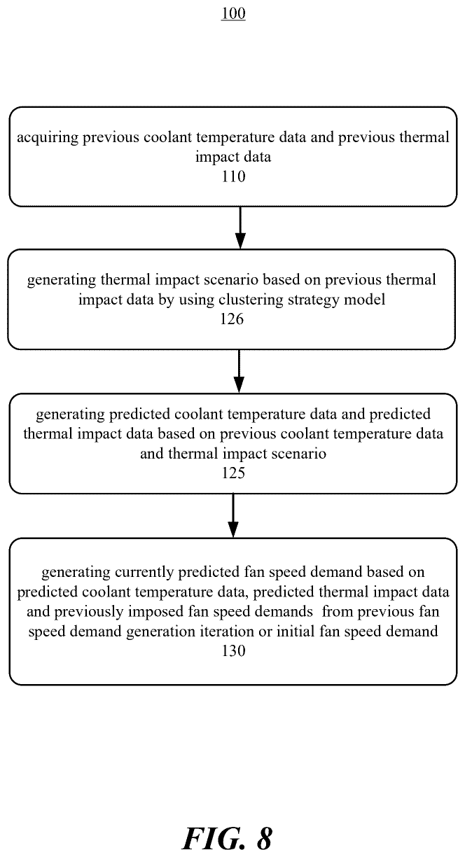

Reference now is made to FIG. 7. During the present fan speed demand generation iteration, according to some embodiments, after the previous coolant temperature data and the previous thermal impact data may be acquired (block 110), a thermal impact scenario may be generated based on the previous thermal impact data (block 124), and the predicted coolant temperature data and the predicted thermal impact data may thus be generated based on the previous coolant temperature data and the thermal impact scenario (block 125); furthermore, according to some embodiments, as can be seen in FIG. 8, the thermal impact scenario may be generated based on the previous thermal impact data by using a clustering strategy model (block 126).

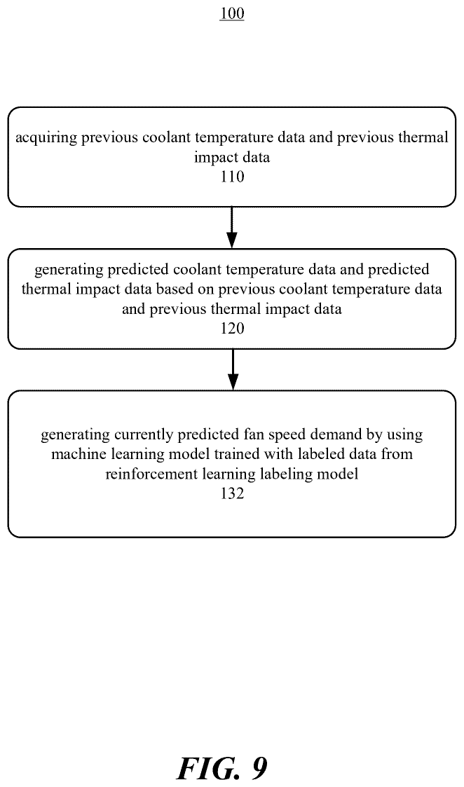

The currently predicted fan speed demand may be generated by using a reinforcement learning labeling model (block 132) during the present fan speed demand generation iteration, according to some embodiments, as can be seen in FIG. 9. For example, the currently predicted fan speed demand may be generated by using a machine learning model trained with labeled data from a reinforcement learning labeling model. FIG. 10 shows an example of a reinforcement learning labeling model for the training of a machine learning model. The reinforcement learning (RL) labeling strategy is used to generate fan speed demands as labels in optimizing the regulation of coolant temperature to a configurable setpoint, in the case of a trainable controller or control model. A better understanding of the reinforcement learning model can be achieved in the diagram in FIG. 10 and in the following description. As in the diagram, an accurate coolant temperature prediction model for a given vehicle, as a thermal response neural network, is an RL environment, which receives a range of previous thermal impact variables and outputs a thermal response state as a coolant temperature discrete space (array). At each RL labeling iteration an RL agent (controller) maps the current thermal response state to the best probabilistic action to take on the environment. These actions can be expressed as accumulated gains over a base fan speed discrete space (array) that iteratively and/or episodically reinforce the probabilistic strategy of the agent, decreasing the number of iterations until a desirable error from a defined coolant temperature setpoint, optimized over a base controller performance such as the PID (Proportional-Integral-Derivative), is achieved for a defined number of data frames, intending the training of machine learning controller models with RL labeled data. In other words, there may be four major steps of the Reinforcement Learning Labeling Model Training: 1) acquiring thermal impact environments; 2) performing the reinforcement learning labeling process: 3) storing thermal impact environments with labeled and optimized fan speed discrete spaces; 4) training a machine learning fan speed demand generation model. There may be an Reinforcement Learning Labeling Model Episode as follows: 1) acquiring thermal impact environment variables: 2) predicting the initial coolant temperature discrete space from a coolant temperature prediction model with current thermal impact environment inputs; 3) generating a discrete gain for the current fan speed demand discrete space from a reinforcement learning agent inference, accumulating over previous discrete space gains; 4) predicting the current coolant temperature discrete space from a coolant temperature prediction model with the current fan speed discrete space; 5) repeating steps 3 to 4 for a defined number of iterations in applying an optimal number of accumulated gains in the fan speed demand discrete space, additionally reinforcing the reinforcement learning agent probabilistic strategy to improve its action quality and labeling speed if an iterative update of the agent probabilistic strategy is adopted; 6) reinforcing the reinforcement learning agent probabilistic strategy to improve its action quality and labeling speed if an episodic update of the agent probabilistic strategy is adopted; 7) storing labeled and optimized fan speed demands for one thermal impact environment.

According to some embodiments, as can be seen in FIG. 13, the present fan speed demand generation iteration may start before a previous fan speed demand selection and control signal generation iteration (block 800) (as shown in FIG. 12) ends, so as to maintain a continuous flow of predicted fan speed demands based in known fan speed generation and control delays. For example, a first fan speed demand selection and control signal generation iteration may be performed in response to that a first fan speed demand generation iteration may be performed, while a second fan speed demand selection and control signal generation iteration may be performed in response to that a second fan speed demand generation iteration may be performed; when the present fan speed demand generation iteration may be the second fan speed demand generation iteration, the second fan speed demand generation iteration may start before the first fan speed demand selection and control signal generation iteration ends.

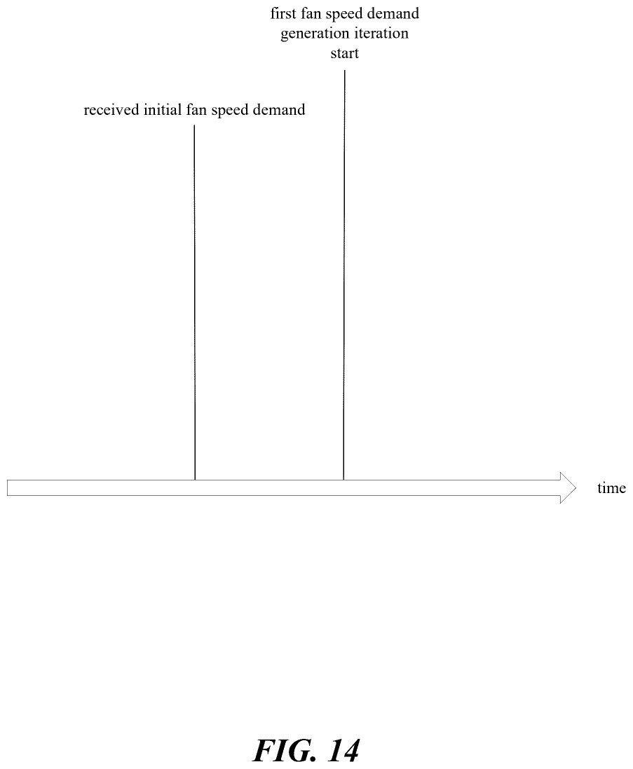

On the other hand, according to some embodiments, as can be seen in FIG. 14, the present fan speed demand generation iteration may start when (i.e., parallel to) or after an initial fan speed demand is received, for example, when the present fan speed demand generation iteration may be the very first fan speed demand generation iteration.

According to some embodiments, in an aspect, the present coolant temperature data and thermal impact data generation process may start before a previous present fan speed demand generation process may end, and a subsequent coolant temperature data and thermal impact data generation process may start before the present fan speed demand generation process may end.

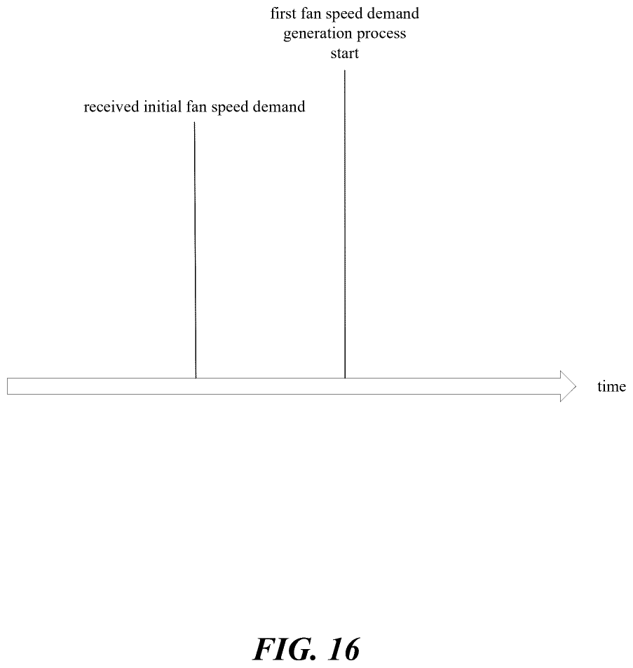

According to some embodiments, in an aspect, as can be seen in FIG. 16, the present fan speed demand generation process may start when or after the initial fan speed demand may be received.

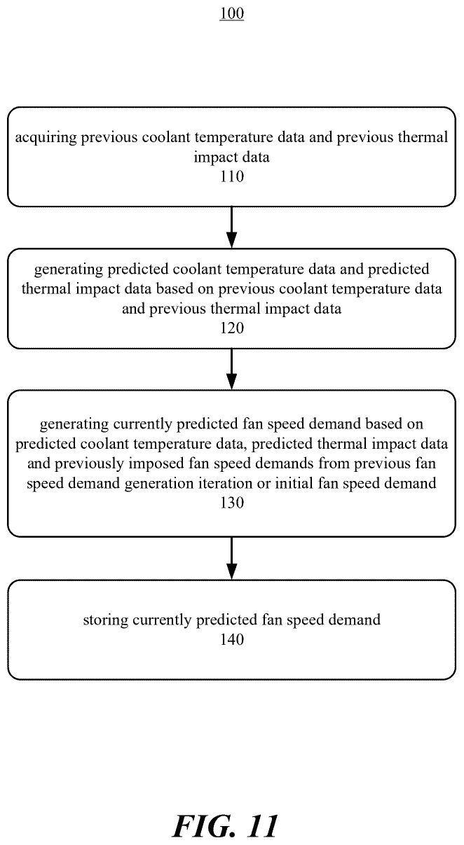

After the currently predicted fan speed demand may be generated, during the present fan speed demand generation iteration (block 130), according to some embodiments, the currently predicted fan speed demand may be stored (block 140), as can be seen in FIG. 11.

As the currently predicted fan speed demand may be stored during the present fan speed demand generation iteration, according to some embodiments, as can be seen in FIG. 12, a subsequent fan speed demand generation iteration may be performed (block 300) in response to that the present fan speed demand selection and control signal generation iteration may be performed (block 200), and a subsequent fan speed demand selection and control signal generation iteration may be performed (block 400) in response to that the subsequent fan speed demand generation iteration may be performed (block 300). Operations of performing (300) the subsequent fan speed demand generation iteration may be similar to operations of performing (100) the present fan speed demand generation iteration, while of performing (400) the subsequent fan speed demand selection and control signal generation iteration may be similar to operations of performing (200) the present fan speed demand selection and control signal generation iteration.

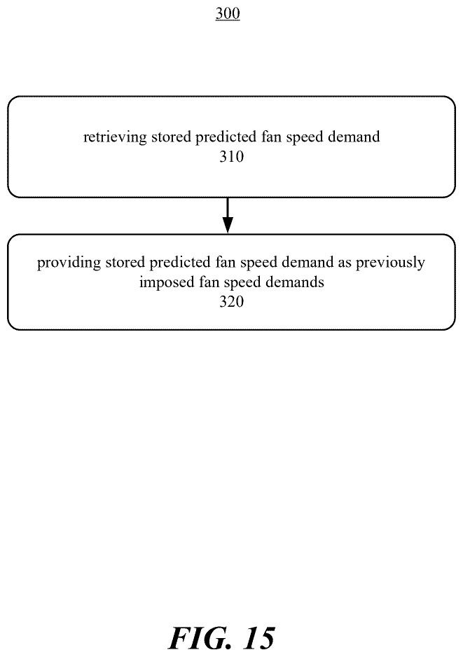

Furthermore, according to some embodiments, as can be seen in FIG. 15, during the subsequent fan speed demand generation iteration, the stored predicted fan speed demand may be retrieved (block 310), and the stored predicted fan speed demand may be provided (320) as one of the previously imposed fan speed demands from a previous fan speed demand generation iteration, i.e., a fan speed demand generation iteration just prior to the subsequent fan speed demand generation iteration.

Similarly, according to some embodiments, the subsequent fan speed demand generation iteration may start before the present fan speed demand selection and control signal generation iteration ends, as can be seen in FIG. 13. For example, when the subsequent fan speed demand generation iteration may be the second fan speed demand generation iteration and the present fan speed demand selection and control signal generation iteration may be the first fan speed demand selection and control signal generation iteration, the second fan speed demand generation iteration may start before the first fan speed demand selection and control signal generation iteration ends.

FIG. 17 is a schematic diagram illustrating a system 500 which is used to perform the above recited method. Specifically, the system 500 may be a system of controlling vehicle fan speed to regulate coolant temperature according to some embodiments.

As illustrated in FIG. 17, according to some embodiments, the system 500 may comprise a processor 510, a sensor 520 and a memory 530. The sensor 520 may be electrically coupled with the processor 510, and the memory 530 may also be electrically coupled with the processor 510. The processor 510 may be configured to perform the above recited operations of fan speed demand generation iteration(s) and fan speed demand selection and control signal generation iteration(s). For example, the processor 510 may acquire the previous coolant temperature data and the previous thermal impact data via the sensor 520, and may store the currently predicted fan speed demand in the memory 530.

FIG. 18 is a schematic diagram illustrating a computer program product 600 which is used to perform the above recited method. Specifically, the computer program product 600 may be used to control vehicle fan speed to regulate coolant temperature according to some embodiments.

As illustrated in FIG. 18, according to some embodiments, the computer program product 600 may comprise a non-transitory computer readable medium 610 and a program code 620. The program code 620 may be stored in the non-transitory computer readable medium 610 that when executed by the above recited system 500 causes the system 500 to perform the above recited method.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of controlling vehicle fan speed to regulate coolant temperature, the method comprising:
performing a present fan speed demand generation iteration comprising:
acquiring previous coolant temperature data and previous thermal impact data, wherein the previous thermal impact data is associated with the previous coolant temperature data;
generating predicted coolant temperature data and predicted thermal impact data based on the previous coolant temperature data and the previous thermal impact data, wherein the predicted thermal impact data is associated with the predicted coolant temperature data; and
generating a currently predicted fan speed demand for a vehicle fan hardware based on the predicted coolant temperature data, the predicted thermal impact data and previously imposed fan speed demands for the vehicle fan hardware from a previous fan speed demand generation iteration or an initial fan speed demand for the vehicle fan hardware; and
in response to performing the present fan speed demand generation iteration, performing a present fan speed demand selection and control signal generation iteration comprising:
receiving a real-time fan speed demand for the vehicle fan hardware;
comparing the currently predicted fan speed demand with the real-time fan speed demand;
determining a highest fan speed demand for the vehicle fan hardware among the currently predicted fan speed demand and the real-time fan speed demand; and
generating a control signal for controlling vehicle fan speed of the vehicle fan hardware based on the highest fan speed demand.

2. The method of claim 1, wherein
performing the present fan speed demand generation iteration further comprising:
generating the predicted coolant temperature data and the predicted thermal impact data by using a coolant temperature and thermal impact prediction model.

3. The method of claim 1, wherein
performing the present fan speed demand generation iteration further comprising:
generating a thermal impact scenario based on the predicted thermal impact data; and
generating the currently predicted fan speed demand based on the predicted coolant temperature data, the thermal impact scenario and the previously imposed fan speed demands or the initial fan speed demand.

4. The method of claim 3, wherein
performing the present fan speed demand generation iteration further comprising:
generating the thermal impact scenario by using a clustering strategy model.

5. The method of claim 1, wherein
performing the present fan speed demand generation iteration further comprising:
generating a thermal impact scenario based on the previous thermal impact data; and
generating the predicted coolant temperature data and the predicted thermal impact data based on the previous coolant temperature data and the thermal impact scenario.

6. The method of claim 5, wherein
performing the present fan speed demand generation iteration further comprising:
generating the thermal impact scenario by using a clustering strategy model.

7. The method of claim 1, wherein
performing the present fan speed demand generation iteration further comprising:
generating the currently predicted fan speed demand by using a reinforcement learning labeling model.

8. The method of claim 1, wherein
the present fan speed demand generation iteration starts before a previous fan speed demand selection and control signal generation iteration ends.

9. The method of claim 1, wherein
the present fan speed demand generation iteration starts when or after the initial fan speed demand is received.

10. The method of claim 1, wherein
performing the present fan speed demand generation iteration further comprising:
storing the currently predicted fan speed demand.

11. The method of claim 10 further comprising:
in response to performing the present fan speed demand selection and control signal generation iteration, performing a subsequent fan speed demand generation iteration comprising:
retrieving the stored predicted fan speed demand; and
providing the stored predicted fan speed demand as one of the previously imposed fan speed demands.

12. The method of claim 11, wherein
the subsequent fan speed demand generation iteration starts before the present fan speed demand selection and control signal generation iteration ends.

13. The method of claim 11 further comprising:
in response to performing the subsequent fan speed demand generation iteration, performing a subsequent fan speed demand selection and control signal generation iteration.

14. The method of claim 1, wherein
acquiring the previous coolant temperature data and the previous thermal impact data, and generating the predicted coolant temperature data and the predicted thermal impact data in the present fan speed demand generation iteration are referred as a present coolant temperature data and thermal impact data generation process,
generating the currently predicted fan speed demand in the present fan speed demand generation iteration is referred as a present fan speed demand generation process,
receiving the real-time fan speed demand, and comparing the currently predicted fan speed demand with the real-time fan speed demand in the present fan speed demand selection and control signal generation iteration are referred as a present real-time comparative process, and
determining the highest fan speed demand, and generating the control signal in the present fan speed demand selection and control signal generation iteration are referred as a present control signal generation process.

15. The method of claim 14, wherein
the present coolant temperature data and thermal impact data generation process starts before a previous present fan speed demand generation process ends.

16. The method of claim 14, wherein
a subsequent coolant temperature data and thermal impact data generation process starts before the present fan speed demand generation process ends.

17. The method of claim 14, wherein
the present fan speed demand generation process starts when or after the initial fan speed demand is received.

18. A system of controlling vehicle fan speed to regulate coolant temperature, the system comprising:
a processor; and
a sensor electrically coupled with the processor,
wherein the processor is configured to perform operations comprising:
performing a present fan speed demand generation iteration comprising:
acquiring previous coolant temperature data and previous thermal impact data via the sensor, wherein the previous thermal impact data is associated with the previous coolant temperature data;
generating predicted coolant temperature data and predicted thermal impact data based on the previous coolant temperature data and the previous thermal impact data, wherein the predicted thermal impact data is associated with the predicted coolant temperature data; and
generating a currently predicted fan speed demand for a vehicle fan hardware based on the predicted coolant temperature data, the predicted thermal impact data and previously imposed fan speed demands for the vehicle fan hardware from a previous fan speed demand generation iteration or an initial fan speed demand for the vehicle fan hardware; and
in response to performing the present fan speed demand generation iteration, performing a present fan speed demand selection and control signal generation iteration comprising:
receiving a real-time fan speed demand for the vehicle fan hardware;
comparing the currently predicted fan speed demand with the real-time fan speed demand;
determining a highest fan speed demand for the vehicle fan hardware among the currently predicted fan speed demand and the real-time fan speed demand; and
generating a control signal for controlling vehicle fan speed of the vehicle fan hardware based on the highest fan speed demand.

19. The system of claim 18, wherein
performing the present fan speed demand generation iteration further comprising:
generating the predicted coolant temperature data and the predicted thermal impact data by using a coolant temperature and thermal impact prediction model.

20.-34. (canceled)

35. A computer program product of controlling vehicle fan speed to regulate coolant temperature, the computer program product comprising:
a non-transitory computer readable medium; and
a program code stored in the non-transitory computer readable medium that when executed by a system causes the system to perform operations comprising:
performing a present fan speed demand generation iteration comprising:
acquiring previous coolant temperature data and previous thermal impact data, wherein the previous thermal impact data is associated with the previous coolant temperature data;
generating predicted coolant temperature data and predicted thermal impact data based on the previous coolant temperature data and the previous thermal impact data, wherein the predicted thermal impact data is associated with the predicted coolant temperature data; and
generating a currently predicted fan speed demand for a vehicle fan hardware based on the predicted coolant temperature data, the predicted thermal impact data and previously imposed fan speed demands for the vehicle fan hardware from a previous fan speed demand generation iteration or an initial fan speed demand for the vehicle fan hardware; and
in response to performing the present fan speed demand generation iteration, performing a present fan speed demand selection and control signal generation iteration comprising:
receiving a real-time fan speed demand for the vehicle fan hardware;
comparing the currently predicted fan speed demand with the real-time fan speed demand;
determining a highest fan speed demand for the vehicle fan hardware among the currently predicted fan speed demand and the real-time fan speed demand; and
generating a control signal for controlling vehicle fan speed of the vehicle fan hardware based on the highest fan speed demand.

36.-51. (canceled)
